(19) United States
(12) Patent Application Publication
(10) Pub. No.: US 2008/0250180 A1
(43) Pub. Date: Oct. 9, 2008

(54) USB peripheral device with dynamic modification class and operation method of the same

(76) Inventors: Chi-Tung Chang, Taipei (TW); Shin-Min Lan, Taipei (TW); Chao-Yu Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/155,778

(22) Filed: Jun. 10, 2008

Related U.S. Application Data
(62) Division of application No. 11/594,801, filed on Nov. 9, 2006.

(51) Int. Cl. G06F 13/00

(52) U.S. Cl. 710/301

(57) ABSTRACT

A USB peripheral device with dynamic modification class is connected to a basic system of processor through a USB transmission interface. The USB peripheral device contains a card connection unit and a USB microprocessor. By judging whether the card connection unit is inserted with a card device, the USB microprocessor is determined to transmit the data or not with the basic system of processor. If one card device is inserted into the card connection unit, the USB microprocessor outputs the corresponding class code according to the device class of the card device for the basic system of processor distinguishing and confirming said class code. Therefore, dynamically changing the device class in accordance with various card devices is achieved.

### RELATED APPLICATIONS

This application is a Divisional patent application of co-pending application Ser. No. 11/594,801, filed on 9 Nov. 2006. The entire disclosure of the prior application Ser. No. 11/594,801, from which an oath or declaration is supplied, is considered a part of the disclosure of the accompanying Divisional application and is hereby incorporated by reference.

### BACKGROUND OF THE INVENTION

1. Field of the Invention

The present invention relates to a USB peripheral device and an operation method of the same, particularly relates to a USB peripheral device with dynamic modification class and an operation method of the same.

2. Background of the Invention

In recent years, USB makes convenient and easy connections to communicate PC and the peripherals because of its low fare and stable adaptation. Similar to dominating protocols UART and RS-232 in the 20th century, USB is an essential standard interface in the 21st century. A storage media for saving data develops from the magnetic disc, the optical disc to various memory cards those are for public already. These memory cards save and load data from the main system via the memory-card-record-and-read device, such as a USB memory card reader. As the communication development goes by, more and more memory card interface are provided for mobile communication technology to connect with memory card devices, such as SDIO device, MSIO device or CF+ device. These mobile communication devices can read and record the memory card and even connect with the memory card interface device via the same interface. For the USB card readers applying for the host, connecting with the memory card interface device is necessary and desirable. The USB card reader is hosted with USB interface, unlike COM port arranged of the memory-card-record-and-read device on the mobile communication device. According to the USB specification, here are some procedures. When the USB peripheral device connects to the host, the host system goes to the “Enumeration” step to verify the where the bus connects. The USB peripheral device feeds back the “device class” per se to distinguish the class to give corresponding transmission mode. But the USB card reader and the memory card interface device represent different classes in USB specification. For example, the USB card reader connecting with the host and feeds back the device class per se, which belongs to “USB Mass Storage” class, results in the restraint on read and record for memory card. If the USB interface device is changed or is instead of other device, the host will not be informed and the device class will not be modified.

Hence, an improvement over the prior art is required to overcome the disadvantages thereof.

### SUMMARY OF THE INVENTION

The primary object of the invention is therefore to specify a USB peripheral device and an operation method of the same. When a USB peripheral device connects with a basic system of processor, information about whether a card device is connected is judged first. Then, data transmission is decided, and steps of device enumeration and device class are fed back in accordance with the card device. Dynamically changing the device class corresponding to various card devices is achieved thereby.

According to the invention, the object is achieved to provide a USB peripheral device with dynamic modification class, which is connected to a basic system of processor through a USB transmission interface. The USB peripheral device includes a card connection unit receiving a card device for data transmission, and a USB microprocessor electrically connected between the USB transmission interface and the card connection unit. The card connection unit transmits a detection signal while the card device inserts. The USB microprocessor includes a signal control unit transforming serial data from the basic system of processor, a card interface module receiving the detection signal and transmitting recorded data in the card device, a central unit electrically connected between the card interface module and the signal control unit, and outputting a class code in accordance with the device class of the card device to the basic system of processor; and a pending control unit determining the USB microprocessor to go to a pending status according to a reception of the detection signal. The signal control unit goes to a shut status while the USB microprocessor goes to the pending status, and no data transmission between the USB peripheral device and basic system of processor is done.

According to the invention, the object is achieved to provide an operation method of a USB peripheral device with dynamic modification class, which is adapted for a basic system. The operation method includes steps of: judging whether the USB peripheral device connects with a card device; going to an initializing procedure via a USB microprocessor, if the USB peripheral device connects with the card device; outputting a corresponding class code to a basic system of processor according to a device class of the card device; processing recorded data between the card device and basic system of processor; and by repeating these steps for accomplishing the operation method.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a block diagram of a USB peripheral device with dynamic modification class according to the present invention;

FIG. 2 is a block diagram of the USB microprocessor according to another embodiment of the present invention; and

FIG. 3 is a flow chart of an operation method according to a preferred embodiment of the USB peripheral device with dynamic modification class.

### DETAILED DESCRIPTION OF THE EMBODIMENTS

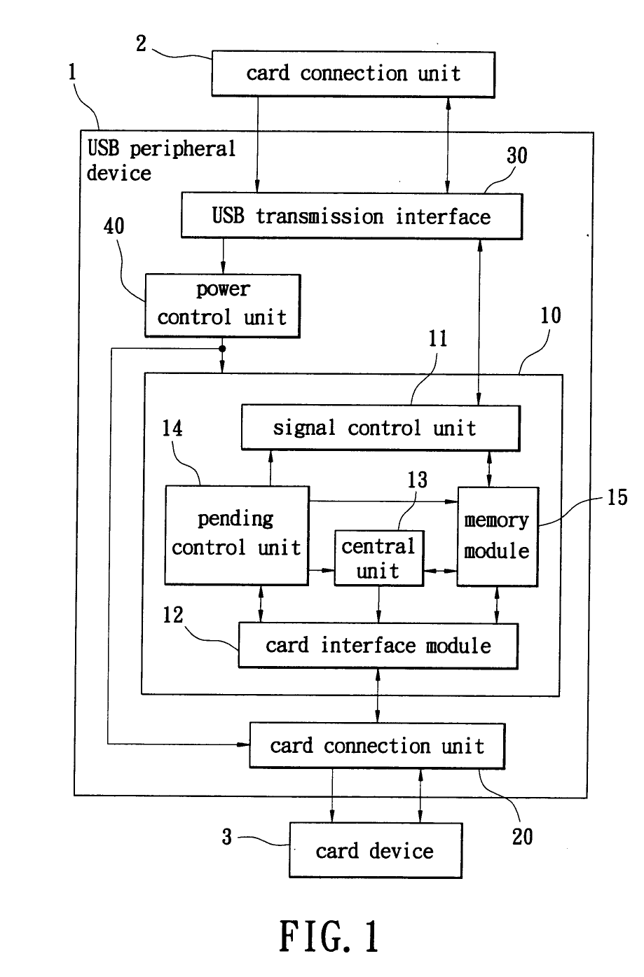

With reference with FIG. 1, a USB peripheral device 1 with dynamic modification class according to the present invention is provided. The USB peripheral device 1 includes a USB microprocessor 10, a card connection unit 20 and a USB transmission interface 30. The USB transmission interface 30 connects to a basic system of processor 2. The card connection unit 20 can receive a card device 3 and transit the recorded data from the card device 3. At the time of the insertion of the card device 3, the card connection unit 20 deliveries detection signal. The USB microprocessor 10 electrically connects between the USB transmission interface 30 and the card connection unit 20. The USB microprocessor 10 transforms and transmits data between the USB transmission interface 30 and the card connection unit 20. And only after the detection signal is received, the USB microprocessor 10 transits data to the basic system of processor.

The USB peripheral device 1 includes a power control unit 40, such as a voltage transform circuit, to receive a first voltage form the basic system of processor through the USB transmission interface 30. The power control unit 40 transforms the first voltage to a second voltage and transits the second voltage to both of the USB microprocessor 10 and the card device 3 via the card connection unit 20.

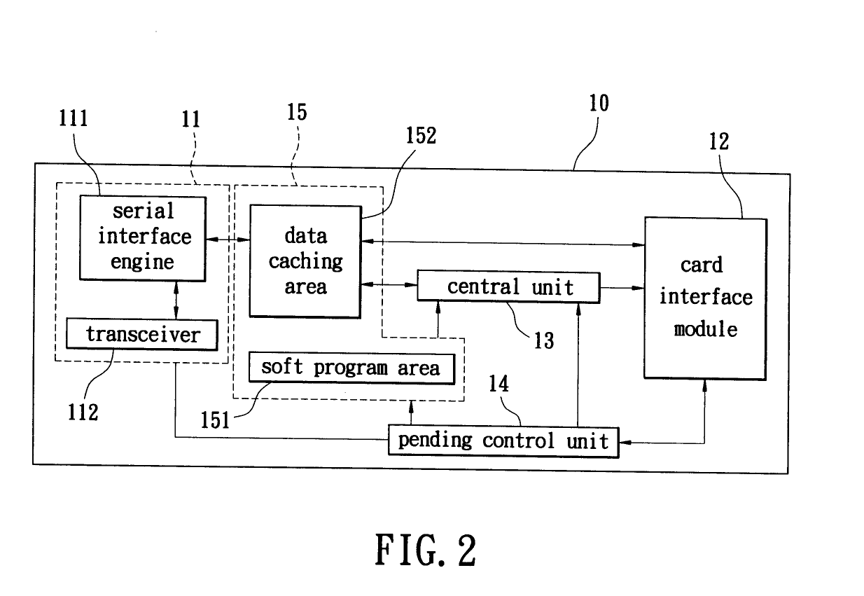

Referring to FIG. 2, the USB microprocessor 10, according to the present invention, includes a signal control unit 11, a card interface module 12, a central unit 13 and a pending control unit 14. The signal control unit 11 transforms serial data from the basic system of processor 2. The card interface module 12 receives the detection signal and transmits recorded data in the card device 3. The central unit 13 electrically connects between the card interface module 12 and the signal control unit 11. The central unit 13 outputs a class code in accordance with the device class of the card device 3 to the basic system of processor 2, so that the “Enumeration” of the device 1 can be accomplished via the basic system of processor 2 and the central unit 13 generates corresponding transmission mode. In addition, the pending control unit 14 determines the USB microprocessor 10 to go to a pending status, while the card device 3 doesn't insert into the USB peripheral device 1 and doesn't receive the detection signal. The signal control unit 11 is shut thereby, and the USB peripheral device 1 didn't connect to the basic system of processor 2 and transmits data therefore.

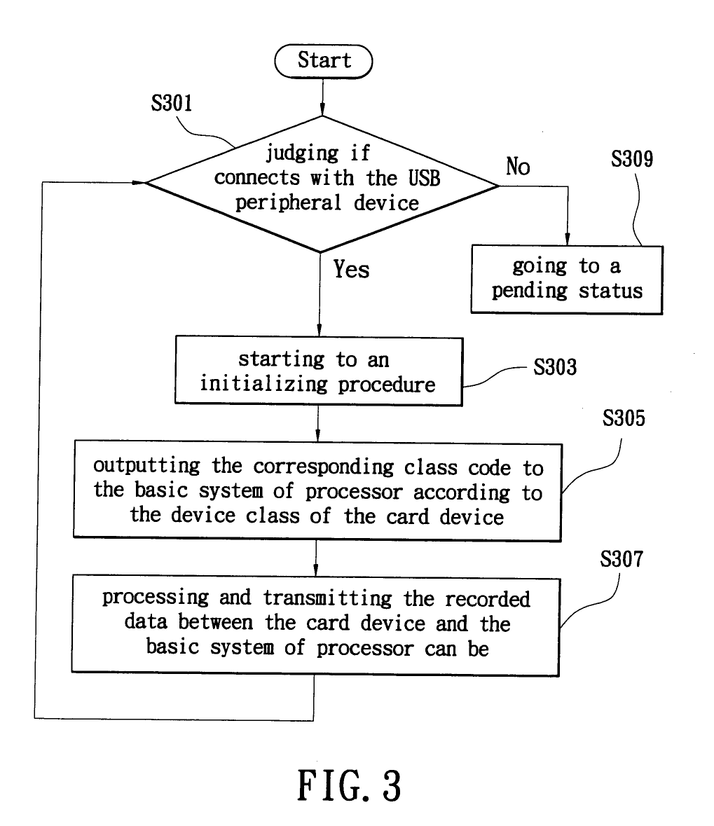

The USB microprocessor 10 includes a memory module 15, which maybe a soft program area 151 and a data caching area 152. The soft program area 151, is a Read Only Memory (ROM), stores the currency program of the USB microprocessor 10. The data caching area 152, a Random Access Memory (RAM), stores the recorded data transmitted between the basic system of processor 2 and the card device 3 for a short time. Referring FIG. 3, a flow chart of an operation method of the USB peripheral device 1 with dynamic modification class according to the present invention is provided. The operation method of the USB peripheral device 1 is adapted for a basic system 2. The operation method of the USB peripheral device 1 includes: whether the USB microprocessor 10 receives the detection signal is for judging if connects with the USB peripheral device 3 (S301). If the USB peripheral device 1 connects any card device 3, the basic system of processor 2 and the USB microprocessor 10 starts to an initializing procedure (S303). Then, the USB microprocessor 10 outputs the corresponding class code to the basic system of processor 2 according to the device class of the card device 3 (S305). The initialization procedure means any USB peripheral device 1 reports the motion and property per se while connects to the basic system of processor 2, and the basic system of processor 2 distinguishes and manages the status of the device via the step of “Enumeration”. For example, if a memory card is inserted, “Mass Storage Device Class” codes output. If an SDIO-global position system is inserted, that is categorized into Class B. After the USB peripheral device 1 and the basic system of processor 2 are verified and confirmed, the recorded data between the card device 3 and the basic system of processor 2 can be processed and transmitted (S307). On the contrary, if the USB peripheral device 1 connects no card device 3, the USB microprocessor 10 goes to a pending status (S309). The signal control unit 11 is shut, and the basic system of processor 2 cannot distinguish connections of any USB peripheral device 1 thereby. By repeating the steps mentioned above, the USB peripheral device 1 could be modified as a different USB device class in accordance with various card device 3.

The card connection unit 20 can be a card socket having at least one slot. The card device 3 is a memory card or a memory card interface device. The memory card interface device includes SDIO card (, such as SDIO-global position system and SDIO-blue device,) applied for SD interface, MSIO card applied for MS interface, or CF+card applied for CF interface. The signal control unit 11 includes a serial interface engine 111 and a transceiver 112, in order to implement coding, decoding, error code checking and correcting, byte stuffing, and transition and transaction.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A USB microprocessor with dynamic modification class adapted for a USB peripheral device, comprising:
a signal control unit transforming serial data from the basic system of processor;
a card interface module receiving the detection signal and transmitting recorded data in the card device;
a central unit electrically connected between the card interface module and the signal control unit, and outputting a class code in accordance with the device class of the card device to the basic system of processor; and
a pending control unit determining the USB microprocessor to go to a pending status according to a reception of the detection signal;
wherein the signal control unit goes to a shut status while the USB microprocessor goes to the pending status, and no data transmission between the USB peripheral device and basic system of processor is done.

2. The USB microprocessor with dynamic modification class as claimed in claim 1, wherein the signal control unit includes a serial interface engine and a transceiver.

3. The USB microprocessor with dynamic modification class as claimed in claim 1, wherein the card device is a memory card or a memory card interface device.

4. The USB microprocessor with dynamic modification class as claimed in claim 3, wherein the memory card interface device includes SDIO card, MSIO card or CF+ card.

5. The USB microprocessor with dynamic modification class as claimed in claim 1 further including a memory module having a soft program area and a data caching area, wherein the soft program area stores the currency program of the USB microprocessor and the data caching area stores the recorded data transmitted between the basic system of processor and the card device for a short time.

6. The USB microprocessor with dynamic modification class as claimed in claim 5, wherein the soft program area is a Read Only Memory (ROM) and the data caching area is a Random Access Memory (RAM).
